(19) United States
(12) Patent Application Publication
(10) Pub. No.: US 2022/0143697 A1
(43) Pub. Date: May 12, 2022

(54) SYSTEM FOR PREPARING NANOSCALE ZERO-VALENT IRON BY REVERSE FILTRATION IN NON-OPEN INERT ATMOSPHERE

(71) Applicant: University of South China, Hengyang City (CN)

(72) Inventors: Yong Liu, Hengyang City (CN); Qianwen Huang, Hengyang City (CN); Xiaowen Zhang, Hengyang City (CN); Yupeng Xie, Hengyang City (CN); Keyou Shi, Hengyang City (CN); Hao Chen, Hengyang City (CN); Shoufu Yu, Hengyang City (CN); Guowen Peng, Hengyang City (CN); Yifan Chen, Hengyang City (CN); Mi Li, Hengyang City (CN); Xiaoyan Wu, Hengyang City (CN); Zhijun Zhang, Hengyang City (CN); Qiucai Zhang, Hengyang City (CN)

(21) Appl. No.: 17/522,545

(22) Filed: Nov. 9, 2021

(30) Foreign Application Priority Data
Nov. 9, 2020 (CN) 202011235540.X

(51) Int. Cl. B22F 9/24; B01D 35/027; B01D 29/11; B01D 5/00; B01J 19/14; B01J 19/00

(52) U.S. Cl. CPC B22F 9/24; B01D 35/0276; B01D 29/114; B01D 5/0072; B22F 2202/05; B01J 19/0066; B22F 2009/245; B22F 2201/10; B22F 2301/35; B01J 19/14

(57) ABSTRACT

A system for preparing nanoscale zero-valent iron by reverse filtration in a non-open inert atmosphere is provided including an inert gas bottle, a gas monitoring and buffering device, a main reaction device configured as a three-necked flask, a condensing device including a condenser tube and a cold source, a waste liquid collecting device configured as a waste liquid collecting bottle, a liquid sealing device including a second liquid sealing bottle connected with the waste liquid collecting bottle through a first connecting-pipe, and an extraction pressure adjusting device including a third triple valve and a vacuum pump, all of which are connected by pipelines in sequence. Three necks of the three-necked flask are respectively provided with a first triple valve, a single-hole rubber plug pierced with a liquid-taking pipe, and a second triple valve. The second liquid sealing bottle is connected with the third triple valve.

### CROSS REFERENCE TO RELATED APPLICATION

This patent application claims the benefit and priority of Chinese Patent Application No. 202011235540.X, entitled “system for preparing nano-sized zero-valent iron by reverse filtration in non-open inert atmosphere” filed with the Chinese Patent Office on Nov. 9, 2020, the disclosure of which is incorporated by reference herein in its entirety.

### TECHNICAL FIELD

The present disclosure relates to the technical field of preparing water treatment materials.

### BACKGROUND ART

In recent years, research of nanoscale zero-valent iron on the treatment of organic pollutants and heavy metal pollutants to the environment have become more common. In comparison with ordinary scrap iron, nanoscale zero-valent iron is smaller in particle size and larger in specific surface area, and thus has stronger reduction activity and dispersibility in the polluted environment. However, nanoscale zero-valent iron is difficult to undergo the solution phase synthesis, as well as to be cleaned, separated and dried in oxygen-containing air atmosphere.

At present, most of laboratories complete the above-mentioned synthesis steps of nanoscale zero-valent iron in a glove box filled with the inert gas. However, most of glove boxes will continuously carry out water removal cycles during operation, and deionized water may be to be used as a solvent for solution phase synthesis of nanoscale zero-valent iron, which will increase the load of the glove box and thus shorten service life of the glove box. Moreover, the glove box has a higher cost in purchase and maintenance, which increases the research cost and sets a threshold for the research of nanoscale zero-valent iron.

To reduce the dependence on equipment for researching nanoscale zero-valent iron, a method comes out for enabling synthesis of nanoscale zero-valent iron by continuously introducing inert gases into the reaction vessel. Although this method eliminates the dependence on the glove box, it wastes a great amount of inert gases, which still results in a higher experimental cost. There are also self-made devices for synthesizing nanoscale zero-valent iron.

### SUMMARY

The purpose of the embodiments is to provide a system for preparing nanoscale zero-valent iron by reverse filtration in a non-open inert atmosphere, for solving the above mentioned problems existing in the prior art, and safely and effectively producing nanoscale zero-valent iron of high purity.

In order to achieve the above purpose, the present disclosure provides the following scheme:

As appreciated by the present inventors, although some conventional devices eliminate the dependence on the glove box and save experimental consumables, there is no material cleaning step during the synthesis of nanoscale zero-valent iron, thus resulting in impure zero-valent iron. Moreover, the nanoscale zero-valent iron requires to be separated in the atmosphere contacting the air, so the zero-valent iron material is susceptible to loss and the content and purity of the zero-valent iron material varies greatly in different batches of zero-valent iron materials.

According, the present disclosure provides a system for preparing nanoscale zero-valent iron by reverse filtration in a non-open inert atmosphere, the system including an inert gas bottle, a gas monitoring and buffering device, a main reaction device, a condensing device, a waste liquid collecting device, a liquid sealing device and an extraction pressure adjusting device which are connected by pipelines in sequence.

The main reaction device is configured as a three-necked flask, the condensing device includes a condenser tube and a cold source in communication with the condenser tube, and the waste liquid collecting device is configured as a waste liquid collecting bottle. One neck of the three-necked flask is connected with a first triple valve, another neck is provided with a single-hole rubber plug, and a rest neck is provided with a second triple valve. The single-hole rubber plug is pierced with a liquid-taking pipe, a top end of the liquid-taking pipe is connected with one end of the condenser tube through one of the pipelines, and a bottom end of the liquid-taking pipe is fixedly provided with a filter head.

The extraction pressure adjusting device includes a third triple valve and a vacuum pump in communication with one port of the third triple valve, and the liquid sealing device includes a second liquid sealing bottle configured to contain water. The second liquid sealing bottle is connected with the waste liquid collecting bottle through a first connecting pipe, and one end of the first connecting pipe is configured to extend into the water contained in the second liquid sealing bottle. The second liquid sealing bottle is connected with the third triple valve through a second connecting pipe, and one end of the second connecting pipe which is close to the second liquid sealing bottle is configured to be located above the water contained in the second liquid sealing bottle.

Preferably, the system also includes a first liquid storage bottle, a second liquid storage bottle and a fourth triple valve. The first liquid storage bottle may be connected with one port of the fourth triple valve, the second liquid storage bottle may be connected with another port of the fourth triple valve, and a rest port of the fourth triple valve may be connected with one port of the first triple valve; the first liquid storage bottle may be configured to contain deionized water, and the second liquid storage bottle may be configured to contain absolute ethyl alcohol.

Preferably, the system also includes a reducing agent bottle and a peristaltic pump. The reducing agent bottle, the peristaltic pump and another port of the first triple valve may be connected in sequence.

Preferably, the cold source may be configured as a cold-water circulating tank, a water outlet of the cold-water circulating tank may be in communication with a water inlet of the condenser tube, and a water inlet of the cold-water circulating tank may be in communication with a water outlet of the condenser tube.

Preferably, one port of the second triple valve may be connected with the three-necked flask, and another port of the second triple valve is connected with a second balloon.

Preferably, the system also includes a thermostatic-heating magnetic stirrer configured for stirring solution in the three-necked flask.

Preferably, the gas monitoring and buffering device may be configured as a comb-shaped glass exhaust tube, and a buffer interface of the comb-shaped glass exhaust tube may be connected with a first balloon.

Preferably, the filter head includes a reticulated ceramic shell which is provided with multiple meshes, a sand core filter layer may be arranged in the reticulated ceramic shell, a filter membrane may be sandwiched between the reticulated ceramic shell and the sand core filter layer, a shell-fixing rubber ring may be embedded in a top of the reticulated ceramic shell, the bottom end of the liquid-taking pipe may penetrate through the shell-fixing rubber ring and may be inserted into the sand core filter layer, and the reticulated ceramic shell and the liquid-taking pipe may be tightly attached to the shell-fixing rubber ring.

In comparison with the prior art, the embodiments have the following technical effects.

The system for preparing nanoscale zero-valent iron by reverse filtration in the non-open inert atmosphere provided in the present disclosure may safely and effectively produce the nanoscale zero-valent iron of high purity. The system for preparing nanoscale zero-valent iron by reverse filtration in the non-open inert atmosphere provided in the present disclosure implements solid-liquid separation according to the principle of filtration and separation. In the prior art, turbid solution is mostly separated by passing through a filter paper from top to bottom. However, in the present disclosure, turbid solution is filtered from bottom to top, so as to prevent an excessively thick filter cake from being formed on the surface of the filter paper and thus to reduce the demand for extraction pressure, thereby solving the problem of filter membrane blockage caused by a small particle size of nano zero-valent iron. The system for preparing nanoscale zero-valent iron by reverse filtration in the non-open inert atmosphere provided in the present disclosure works in the non-open inert atmosphere, so that the inert gas is saved, and the cost of material synthesis is reduced. The system for preparing nanoscale zero-valent iron by reverse filtration in the non-open inert atmosphere provided in the present disclosure avoids the contact with air during the synthesis of nanoscale zero-valent iron, and can thus reduce the zero-valent iron material loss and improve the zero-valent iron material purity.

### BRIEF DESCRIPTION OF THE DRAWINGS

In order to illustrate the embodiments of the present disclosure or technical schemes in the prior art more clearly, the accompanying drawings required in the embodiments will be briefly introduced below. The drawings in the following description are only some embodiments of the present disclosure, and those of ordinary skills in the art may obtain other drawings according to these drawings without creative work.

FIG. 1 is a schematic structural diagram of a system for preparing nanoscale zero-valent iron by reverse filtration in a non-open inert atmosphere according to the present disclosure;

FIG. 2 is a first partial schematic structural diagram of the system for preparing nanoscale zero-valent iron by reverse filtration in the non-open inert atmosphere according to the present disclosure;

FIG. 3 is a second partial schematic structural diagram of the system for preparing nanoscale zero-valent iron by reverse filtration in the non-open inert atmosphere according to the present disclosure;

FIG. 4 is a third partial schematic structural diagram of the system for preparing nanoscale zero-valent iron by reverse filtration in the non-open inert atmosphere according to the present disclosure;

FIG. 5 is a fourth partial schematic structural diagram of the system for preparing nanoscale zero-valent iron by reverse filtration in the non-open inert atmosphere according to the present disclosure;

FIG. 6 is a schematic structural diagram of a filter head in the system for preparing nanoscale zero-valent iron by reverse filtration in the non-open inert atmosphere according to the present disclosure.

The reference numerals of drawings: 1, inert gas bottle; 2, first balloon; 3, first liquid storage bottle; 4, second liquid storage bottle; 5, fourth triple valve; 501, tenth port; 502, eleventh port; 503, twelfth port; 6, liquid-taking pipe; 7, single-hole rubber plug; 8, second balloon; 9, first triple valve; 901, first port; 902, second port; 903, third port; 10, second triple valve; 101, fourth port; 102, fifth port; 103, sixth port; 11, reducing agent bottle; 12, peristaltic pump; 13, thermostatic-heating magnetic stirrer; 14, filter head; 141, shell-fixing rubber ring; 142, sand core filter layer; 143, filter membrane; 144, reticulated ceramic shell; 15, condenser tube; 16, cold-water circulating tank; 161, water outlet; 162, water inlet; 17, waste liquid collection bottle; 18, second liquid sealing bottle; 19, third triple valve; 191, seventh port; 192, eighth port; 193, ninth port; 20, vacuum pump; 21, three-necked flask; 22, buffer pipe; 23, first liquid sealing bottle.

### DETAILED DESCRIPTION OF THE EMBODIMENTS

Technical schemes in the embodiments of the present disclosure will be described clearly and completely with reference to the accompanying drawings thereof. The embodiments described herein are only part of, not all of, embodiments in the present disclosure. Based on the embodiments of the present disclosure, all other embodiments obtained by those of ordinary skills in the art without creative work belong to the protection scope of the present disclosure.

The purpose of the embodiments is to provide a system for preparing nanoscale zero-valent iron by reverse filtration in a non-open inert atmosphere, for solving the above mentioned problems existing in the prior art, and safely and effectively producing nanoscale zero-valent iron of high purity.

In order to make the above mentioned purposes, features and advantages of the present disclosure more apparently understood, the present disclosure will be further described with reference to figures and embodiments below.

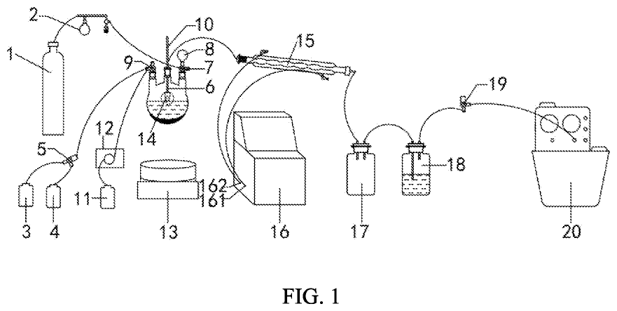

As shown in FIGS. 1-6, this embodiment provides a system for preparing nanoscale zero-valent iron by reverse filtration in a non-open inert atmosphere, which includes an inert gas bottle 1, a gas monitoring and buffering device, a three-necked flask 21, a condenser tube 15, a waste liquid collecting bottle 17, a liquid sealing device, a third triple valve 19 and a vacuum pump 20, all of which are connected by pipelines in sequence.

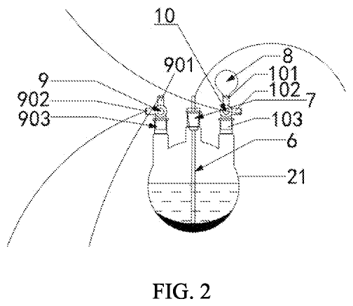

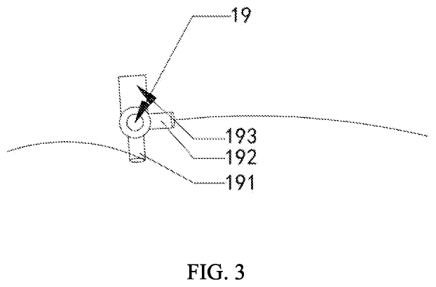

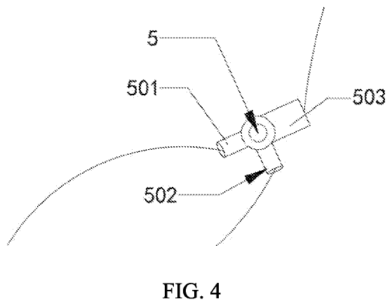

For facilitating distinction, as illustrated in FIG. 2, the three ports of the first triple valve 9 in this embodiment are configured as a first port 901, a second port 902 and a third port 903 respectively; three ports of the second triple valve 10 are configured as a fourth port 101, a fifth port 102 and a sixth port 103 respectively; three ports of the third triple valve 19, as illustrated in FIG. 3, are configured as a seventh port 191, an eighth port 192 and a ninth port 193 respectively; three ports of the fourth triple valve 5 are configured as a tenth port 501, an eleventh port 502 and a twelfth port 503 respectively, as illustrated in FIG. 4.

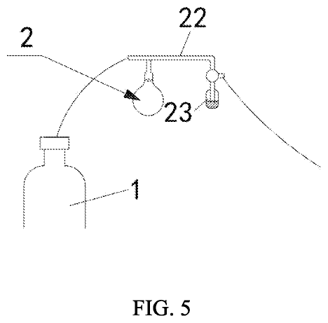

In this embodiment, a comb-shaped glass exhaust tube is used as the gas monitoring and buffering device, and a buffer interface of the comb-shaped glass exhaust tube is connected with a first balloon, and the comb-shaped glass exhaust tube can be directly purchased in the market. Specifically, as illustrated in FIG. 5, the comb-shaped glass exhaust tube includes a buffer pipe 22, a first liquid sealing bottle 23 and an air outlet pipe. One end of the buffer pipe 22 is connected with an inert gas bottle 1 and the other end of the buffer pipe 22 is inserted into water contained in the first liquid sealing bottle 23. One end of the air outlet pipe extends into the first liquid sealing bottle 23 and is located above the water contained in the first liquid sealing bottle 23. The buffer interface of the buffer pipe 22 is also connected with the first balloon 2.

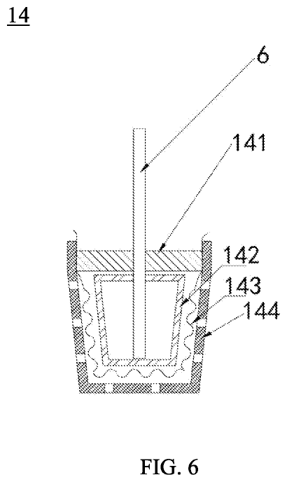

The three-necked flask 21, as illustrated in FIG. 2, has one neck connected with the first triple valve 9, another neck provided with a single-hole rubber plug 7, and a rest neck provided with the second triple valve 10. The third port 903 of the first triple valve 9 is in communication with the three-necked flask 21, the sixth port 103 of the second triple valve 10 is in communication with the three-necked flask 21, and the fourth port 101 of the second triple valve 10 is connected with the second balloon 8. The single-hole rubber plug 7 is pierced with a liquid-taking pipe 6. The top end of the liquid-taking pipe 6 is connected with one end of a condenser tube 15 through a pipeline, and the bottom end of the liquid-taking pipe 6 is fixedly provided with a filter head 14. Specifically, as illustrated in FIG. 6, the filter head 14 includes a reticulated ceramic shell 144 which is provided with multiple meshes. A sand core filter layer 142 is arranged in the reticulated ceramic shell 144. A filter membrane 143 is sandwiched between the reticulated ceramic shell 144 and the sand core filter layer 142. A shell-fixing rubber ring 141 is embedded in the top of the reticulated ceramic shell 144. The bottom end of the liquid-taking pipe 6 penetrates through the shell-fixing rubber ring 141 and is inserted into the sand core filter layer 142. The reticulated ceramic shell 144 and the liquid-taking pipe 6 are tightly attached to the shell-fixing rubber ring 141.

The liquid sealing device includes the second liquid sealing bottle 18. The second liquid sealing bottle 18 is connected with the waste liquid collecting bottle 17 through a first connecting pipe. One end of the first connecting pipe extends into water contained in the second liquid sealing bottle 18. The second liquid sealing bottle 18 is connected with the seventh port 191 of the third triple valve 19 through a second connecting pipe. The eighth port 192 of the third triple valve 19 is connected with the vacuum pump 20. One end of the second connecting pipe which is close to the second liquid sealing bottle 18 is located above the water contained in the second liquid sealing bottle.

The system for preparing nanoscale zero-valent iron by reverse filtration in the non-open inert atmosphere in this embodiment further includes a first liquid storage bottle 3, a second liquid storage bottle 4 and a fourth triple valve 5. The first liquid storage bottle 3 is connected with the tenth port 501 of the fourth triple valve 5. The second liquid storage bottle 4 is connected with the eleventh port 502 of the fourth triple valve 5. The twelfth port 503 of the fourth triple valve 5 is connected with the second port 902 of the first triple valve 9. The first liquid storage bottle 3 contains deionized water, and the second liquid storage bottle 4 contains absolute ethyl alcohol.

The system for preparing nanoscale zero-valent iron by reverse filtration in the non-open inert atmosphere in this embodiment further includes a reducing agent bottle 11 and a peristaltic pump 12. The reducing agent bottle 11, the peristaltic pump 12 and a first port 901 of the first triple valve 9 are connected in sequence.

The system for preparing nanoscale zero-valent iron by reverse filtration in the non-open inert atmosphere in this embodiment also includes a cold-water circulating tank 16. A water outlet 161 of the cold-water circulating tank 16 is in communication with a water inlet of the condenser tube 15, and a water inlet 162 of the cold-water circulating tank 16 is in communication with a water outlet of the condenser tube 15.

The system for preparing nanoscale zero-valent iron by reverse filtration in the non-open inert atmosphere in this embodiment also includes a thermostatic-heating magnetic stirrer 13 for stirring the solution in the three-necked flask 21.

Taking the reduction of FeCl₃ by NaBH₄ to prepare nanoscale zero-valent iron as an example, the system for preparing nanoscale zero-valent iron by reverse filtration in the non-open inert atmosphere in this embodiment is applied as follows.

(1) Firstly, a filter membrane 143 is laid inside the reticulated ceramic shell 144, a sand core filter layer 142 is next disposed inside the filter membrane 143, then a shell-fixing rubber ring 141 is sleeved onto the top of the sand core filter layer 142 from top to bottom, and the shell-fixing rubber ring 141 is inserted into the reticulated ceramic shell 144 and compacted. The reticulated ceramic shell 144 laid with the filter membrane 143 is fixed on the liquid-taking pipe 6 by the elasticity and friction of the shell-fixing rubber ring 141. Next, other parts are connected as shown in FIG. 1, then the first triple valve 9 is taken down to add a certain amount of mixed solution, which is prepared with absolute ethyl alcohol and deionized water, into the three-necked flask 21; a certain amount of FeCl₃ is also added into the three-necked flask 21, and the thermostatic-heating magnetic stirrer 13 starts to stir and dissolve FeCl₃. Finally, the first triple valve 9 is reinstalled, and the third port 903, the sixth port 103 and the seventh port 191 are closed. The liquid-taking pipe 6 is pulled out of the single-hole rubber plug 7 by a certain length, and the filter head 14 at the bottom of the liquid-taking pipe 6 is ensured to be separated from the mixed solution simultaneously.

(2) Check of the air tightness: the vacuum pump 20 is turned on, the seventh port 191 and the eighth port 192 are opened, and the ninth port 193 is closed, which are kept for a while to observe whether the vacuum pump 20 can reach the maximum vacuum value and remain stable or not. If yes, it means that the air tightness of the device is good and the next operation is allowed to perform. If not, it needs to check the air tightness of the device until the vacuum pump 20 reaches the maximum vacuum value and stays stable.

(4) Inflow of an inert gas: the fourth port 101, the fifth port 102, the sixth port 103 and the inert gas bottle 1 are opened, and an inert gas flow rate is adjusted intuitively by observing a bubble generation speed in the first liquid sealing bottle 23 and adjusting the valve of the inert gas bottle 1. The air pressure in the three-necked flask 21 can be determined by observing the second balloon 8. If the second balloon 8 expands, it means that the three-necked flask 21 has a positive pressure inside, so it is necessary to appropriately lower the inert gas flow rate to prevent the air pressure in the three-necked flask 21 from going too high and causing potential safety hazards. If the second balloon 8 contracts, it means that the three-necked flask 21 has a negative pressure inside. At this time, the inert gas flow rate can be appropriately increased to prevent the inert atmosphere from being destroyed due to the rupture of the balloon. The inert gas is introduced for a period of time to eliminate oxygen in the closed device and create an inert gas atmosphere.

(5) Procedure of oxygen-free reduction reaction: sodium borohydride solution with a certain concentration is prepared and slowly added into the three-necked flask 21 via the first port 901 at a certain flow rate through the peristaltic pump 12. The valves of all the seventh port 191, the vacuum pump 20, the fifth port 102 and the inert gas bottle 1 are then closed, and the mixed solution in the three-necked flask 21 is continuously stirred and reacting for a period of time via the thermostatic-heating magnetic stirrer 13.

(6) Filtration and separation: after the reaction ends, the thermostatic-heating magnetic stirrer 13 is shutdown, the vacuum pump 20 is started, and the liquid-taking pipe 6 is moved down until the filter head 14 contacts the bottom of the three-necked flask 21. The inert gas bottle 1 is opened, and the seventh port 191 and the eighth port 192 are immediately opened; then, the filtrate in the three-necked flask 21 is pumped into the waste liquid collection bottle 17. By adjusting the valve on the third triple valve 19, the speed at which the liquid-taking pipe 6 aspirates supernatant fluid can be adjusted, to ensure a slow aspirating speed, thereby avoiding the loss of the product at the bottom.

(7) Cleaning: after the supernatant fluid is aspirated, the liquid-taking pipe 6 is moved up, and the filter head 14 at the bottom end of the liquid-taking pipe 6 is ensured to be separated from the mixed solution. The second port 902, the third port 903, the tenth port 501 and the twelfth port 503 are opened. Then, the deionized water in the first liquid storage bottle 3 is introduced into the three-necked flask 21 under a negative pressure. The filter head 14 is removed, and the three-necked flask 21 is displaced into the thermostatic-heating magnetic stirrer 13 for stirring for a while for cleaning. After cleaning for the first time, Step (6) is repeated for filtration and separation before cleaning again. In the cleaning step, the deionized water is used to clean for several times, and then the absolute ethyl alcohol is used to clean for several times. That deionized water is used firstly and ethyl alcohol is used next to clean reduces the water content in the residual liquid of the product, which facilitates to improve a drying rate of the product.

(8) Drying: after cleaning, the liquid-taking pipe 6 is moved up to ensure that the filter head 14 at the bottom of the liquid-taking pipe 6 is separated from the mixed solution. The three-necked flask 21 is put into the thermostatic-heating magnetic stirrer 13, the temperature is set to above the boiling point of ethyl alcohol, and the rotating speed is lowered to a suitable value to prevent the mixed solution from splashing. The third triple valve 19 and the valve of the inert gas bottle 1 are adjusted to increase the gas flow rate of the reaction system as well as the drying rate of the product in the three-necked flask 21. After the product is dried, the three-necked flask 21 is removed from the thermostatic-heating magnetic stirrer 13, and the circulation of inert gas is remained in the flask. After the three-necked flask 21 is cooled to the room temperature, the eighth port 192 and the ninth port 193 are opened, the vacuum pump 20 is closed, and the inert gas valve is closed. Finally, the product is taken out from the three-necked flask 21 and sealed for storage.

During the reaction, in order to save the inert gas, it is not necessary to keep the inert gas circulating for a long time, whereas it is only necessary to maintain the inert gas atmosphere in the three-necked flask 21. The specific operation is as follows. The third triple valve 19 is adjusted, and the pumping operation of the vacuum pump 20 on the reaction system is stopped. At this time, the inert gas bottle 1 continue to deliver the inert gas to the reaction system, and the inert gas, and in turn the pressure, in the three-necked flask 21 gradually increase, so that the first balloon 2 and the second balloon 8 grow larger. At this time, the air inlet of the first balloon 2 can be blocked, and the second balloon 8 is enabled to grow independently. After the second balloon 8 is filled with sufficient gas, firstly, the second triple valve 10 is adjusted, and the fifth port 102 is closed. After the gas delivery from the inert gas bottle 1 to the reaction system is disconnected, the gas outlet valve of the inert gas bottle 1 is closed next. During the closing of both the fifth port 102 and the inert gas bottle 1, the inert gas delivered from the inert gas bottle 1 can be buffered by the first balloon 2, thus preventing the connecting pipe from bursting due to the excessive gas pressure therein.

In the description of the present disclosure, unless otherwise specified, “top” and “bottom” or the like indicate the orientation or positional relationship based on the orientation or positional relationship shown in the accompanying drawings, which is only for facilitating the description of the present disclosure and simplifying the description, without indicating or implying that the referred devices or elements must have specific orientations, be constructed and operated in specific orientations. Therefore, it should not be construed as limiting the present disclosure. In addition, the terms “first”, “second”, or the like are used for descriptive purposes only and cannot be explained as indicating or implying any relative importance.

Principles and implementation of this present disclosure are described by specific examples, and the explanation of the above embodiments is only used to help understand the method and core idea of the present disclosure. Also, those of ordinary skills in the art may take some modifications in the specific implementation and application scope according to the idea of the present disclosure. To sum up, the content of this specification should not be construed as limiting the present disclosure.

What is claimed is:

1. A system for preparing nanoscale zero-valent iron by reverse filtration in a non-open inert atmosphere, the system comprising:
an inert gas bottle, a gas monitoring and buffering device, a main reaction device, a condensing device, a waste liquid collecting device, a liquid sealing device and an extraction pressure adjusting device which are connected by pipelines in sequence;
the main reaction device is configured as a three-necked flask, the condensing device comprises a condenser tube and a cold source in communication with the condenser tube, and the waste liquid collecting device is configured as a waste liquid collecting bottle; wherein one neck of the three-necked flask is connected with a first triple valve, a second neck is provided with a single-hole rubber plug, and a rest neck is provided with a second triple valve; wherein the single-hole rubber plug is pierced with a liquid-taking pipe, a top end of the liquid-taking pipe is connected with one end of the condenser tube through one of the pipelines, and a bottom end of the liquid-taking pipe is fixedly provided with a filter head;
the extraction pressure adjusting device comprises a third triple valve and a vacuum pump in communication with one port of the third triple valve, and the liquid sealing device comprises a second liquid sealing bottle configured to contain water, wherein the second liquid sealing bottle is connected with the waste liquid collecting bottle through a first connecting pipe, and one end of the first connecting pipe is configured to extend into the water contained in the second liquid sealing bottle; wherein the second liquid sealing bottle is connected with the third triple valve through a second connecting pipe, and one end of the second connecting pipe which is close to the second liquid sealing bottle is configured to be located above a level of the water contained in the second liquid sealing bottle.

2. The system for preparing nanoscale zero-valent iron by reverse filtration in the non-open inert atmosphere according to claim 1, the system further comprising a first liquid storage bottle, a second liquid storage bottle and a fourth triple valve, wherein the first liquid storage bottle is connected with one port of the fourth triple valve, the second liquid storage bottle is connected with a second port of the fourth triple valve, and a rest port of the fourth triple valve is connected with one port of the first triple valve; the first liquid storage bottle is configured to contain deionized water, and the second liquid storage bottle is configured to contain absolute ethyl alcohol.

3. The system for preparing nanoscale zero-valent iron by reverse filtration in the non-open inert atmosphere according to claim 2, the system further comprising:
a reducing agent bottle and a peristaltic pump, wherein the reducing agent bottle, the peristaltic pump and a second port of the first triple valve are connected in sequence.

4. The system for preparing nanoscale zero-valent iron by reverse filtration in the non-open inert atmosphere according to claim 1, wherein the cold source is configured as a cold-water circulating tank, a water outlet of the cold-water circulating tank is in communication with a water inlet of the condenser tube, and a water inlet of the cold-water circulating tank is in communication with a water outlet of the condenser tube.

5. The system for preparing nanoscale zero-valent iron by reverse filtration in the non-open inert atmosphere according to claim 1, wherein a first port of the second triple valve is connected with the three-necked flask, and s second port of the second triple valve is connected with a second balloon.

6. The system for preparing nanoscale zero-valent iron by reverse filtration in the non-open inert atmosphere according to claim 1, the system further comprising a thermostatic-heating magnetic stirrer configured for stirring solution in the three-necked flask.

7. The system for preparing nanoscale zero-valent iron by reverse filtration in the non-open inert atmosphere according to claim 1, wherein the gas monitoring and buffering device is configured as a comb-shaped glass exhaust tube, and a buffer interface of the comb-shaped glass exhaust tube is connected with a first balloon.

8. The system for preparing nanoscale zero-valent iron by reverse filtration in the non-open inert atmosphere according to claim 1, wherein the filter head comprises a reticulated ceramic shell which is provided with a plurality of meshes, a sand core filter layer is arranged in the reticulated ceramic shell, a filter membrane is sandwiched between the reticulated ceramic shell and the sand core filter layer, a shell-fixing rubber ring is embedded in a top of the reticulated ceramic shell, the bottom end of the liquid-taking pipe penetrates through the shell-fixing rubber ring and is inserted into the sand core filter layer, and the reticulated ceramic shell and the liquid-taking pipe are tightly attached to the shell-fixing rubber ring.
